(19) United States
(12) Patent Application Publication
(10) Pub. No.: US 2015/0039531 A1
(43) Pub. Date: Feb. 5, 2015

(54) COMPUTER-BASED INVESTMENT AND FUND ANALYZER

(71) Applicants: John H. Dayani, SR., Brentwood, TN (US); Trey Wallace Dockery, Franklin, TN (US); Mete Fikri, Brentwood, TN (US)

(72) Inventors: John H. Dayani, SR., Brentwood, TN (US); Trey Wallace Dockery, Franklin, TN (US); Mete Fikri, Brentwood, TN (US)

(21) Appl. No.: 13/958,485

(22) Filed: Aug. 2, 2013

(51) Int. Cl. G06Q 40/06

(52) U.S. Cl. CPC G06Q 40/06
USPC 705/36 R

(57) ABSTRACT

A system and a method are disclosed including Graphical User Interface (GUI) components, and one or more software data gathering and analysis components that are used to automatically obtain financial data for company stock selected by a user, compute other intermediate financial parameters and scores for the selected stock, and generate an overall investment score for the particular company stock for support of investment decisions. In various embodiments, the Investment Recommendation and Analysis System (IRAS) generates the overall investment score in multiple intermediate stages based on fundamental financial data and corresponding intermediate scores. The stages may include Fundamentals, Technical, Analyst, and Management stages, each including one or more financial parameters obtained from external sources or calculated. Market conditions are also considered based on trading environment parameters to determine the investment recommendations. In a recommendation stage, detailed investment recommendations are provided based on the other stages.

### TECHNICAL FIELD

This application relates generally to financial analysis. More specifically, this application relates to a computerized method of analyzing stocks and investment funds to generate a score for investment decision support.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example Graphical User Interface (GUI) usable with the computing device of FIG. 2, for selecting and analyzing company stock data;

FIG. 4 shows the example GUI of FIG. 3 with parameters representing fundamental company stock data used in calculating investment scores;

FIG. 5 shows an example stock details page with summary of parameters used to calculate the investment score for a selected stock;

FIG. 6 shows an example stock analyst score obtained based on analysis results of multiple financial analysts;

FIG. 7 shows the example management score obtained based on results of Estimated Per Share (EPS) projections;

FIG. 8 shows an example management performance page with some of the parameters used to evaluate the performance of management of a selected company;

FIG. 9 shows an example trading environment page with summary of industry factors relevant to the overall investment score for the selected company stock; and

FIG. 10 shows an example worksheet including detailed investment recommendations.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references company stock, it will be appreciated that the disclosure may be used with other types of valuable financial instruments, such as stock options, swaps, future options, other stock derivatives, bonds, and the like.

Briefly described, a system and a method are disclosed including Graphical User Interface (GUI) components, and one or more software data gathering and analysis components that are used to automatically obtain financial data for company stock selected by a user, compute other intermediate financial parameters and scores for the selected stock, and generate an overall investment score for the particular company stock for support of investment decisions. In various embodiments, the Investment Recommendation and Analysis System (IRAS) generates the overall investment score in multiple intermediate stages based on fundamental financial data from an industry associated with the selected stock and corresponding intermediate scores. The multiple intermediate stages may include Fundamentals, Technical, Analyst, and Management stages, each including one or more financial parameters used to generate an intermediate score for the respective stage. These parameters may obtained from external sources or be calculated. The parameters include stock prices, earning information, Price to Owner Equity (P/OE), Trailing Growth (TG), Future Growth (FG), and the like. The overall investment score is calculated based on the foregoing stages. In addition to the intermediate stages, their parameters, and their scores, market conditions are considered based on short-term and long-term trading environment parameters to determine the investment recommendations. In a recommendation stage, detailed investment recommendations are provided based on the other stages.

With the ubiquity of computers and users' internet access, there is an ever increasing demand for expanded services and functionality, including efficient, effective, and cost-effective financial and investment services. Because of the expansion of computer-based capabilities and resources, some of the functions of human stock brokers and financial advisors are now performed by computer software and/or online services. Such functions include industry information, trends, statistics, and the like. However, these online or software services are largely limited to factual data and/or simple analysis, and usually lack the sophistication of human analysts.

One of the important financial activities is the purchase and sale of financial instruments in the stock market and similar financial instruments such as options, bonds, and stock derivatives like futures options and the like. Accurate and fast prediction of stock market behavior, in general, and performance of a particular company stock, in particular, are valuable tools for many investors. Such financial tools are especially important when the amount of investment is large. Therefore, fast, accurate, and highly available computerized financial tools, which can help the investor make business and investment decisions are highly desirable.

### Illustrative Operating Environment

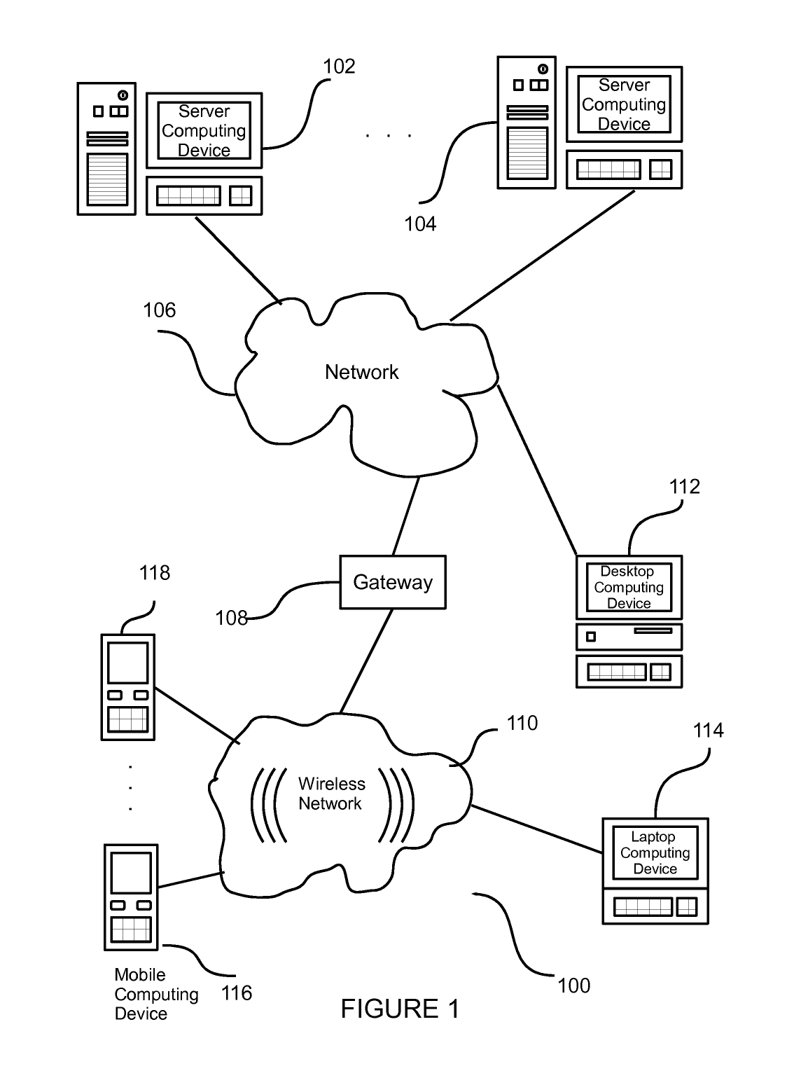

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

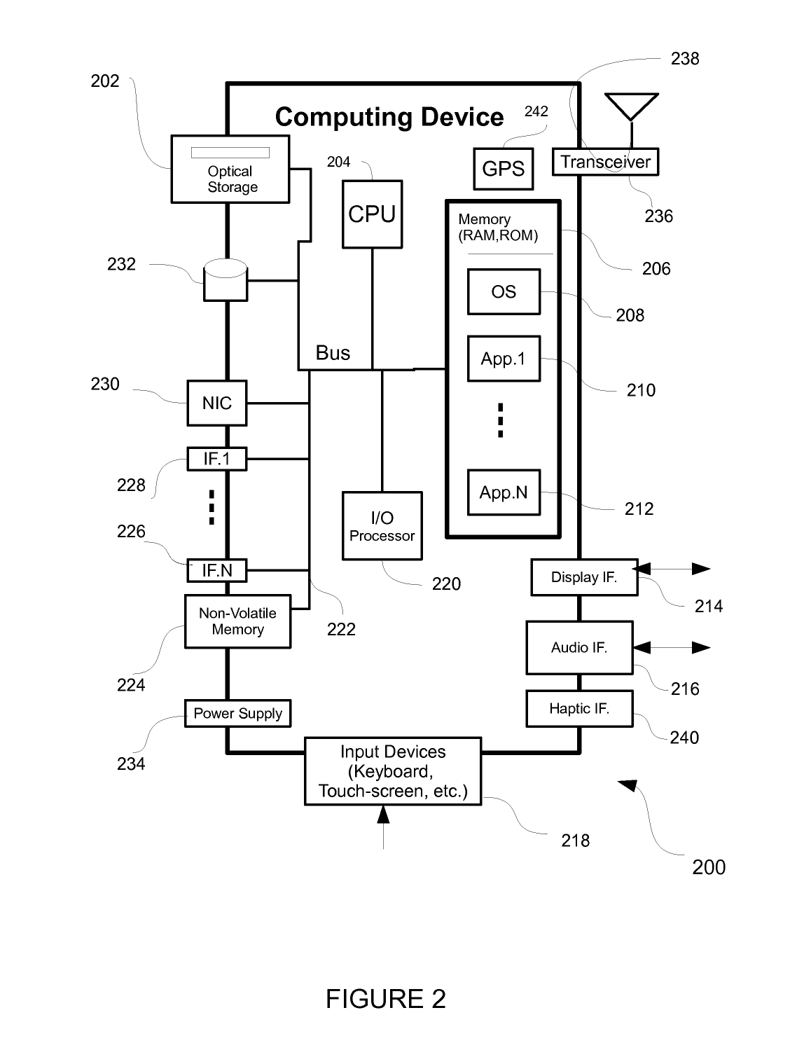

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

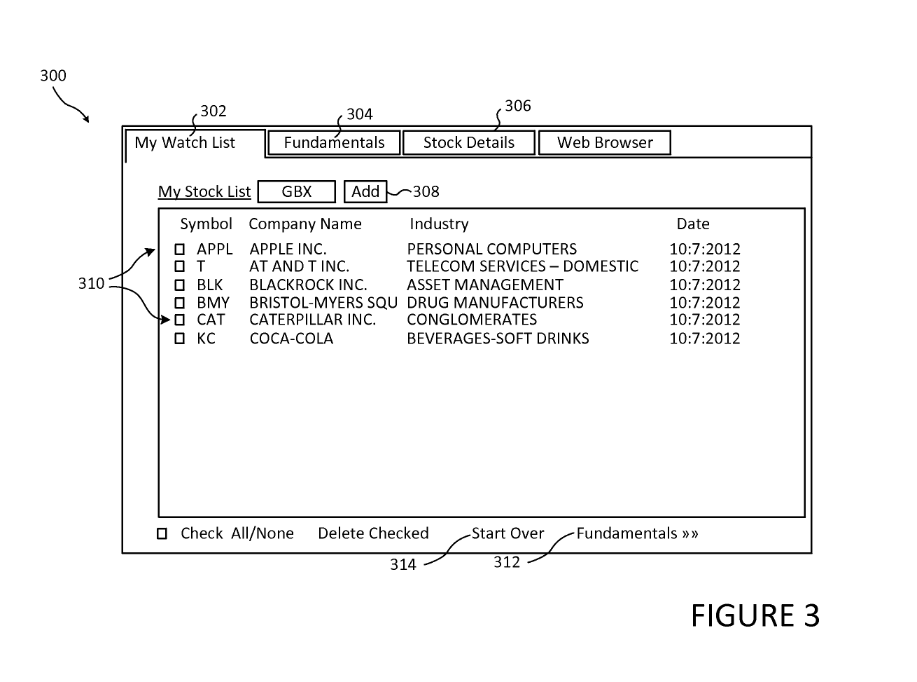

FIG. 3 shows an example Graphical User Interface (GUI) usable with the computing device of FIG. 2, for selecting and analyzing company stock data. In various embodiments, investment analysis and recommendation system 300 includes multiple tabs such as stock watch list tab 302, stock fundamental data tab 304, stock detailed data tab 306, Add control 308 for adding new stock symbols to the watch list, rows of stock data 310, Start Over control 314 for starting the stock selection or analysis process over from the beginning, and next button 314 form moving to next stage such as Fundamentals stage.

In various embodiments, stock watch list tab 302 is a part of the Investment Recommendation and Analysis System (IRAS) 300, and is used to maintain a list of stock an investor or user is interested in monitoring. Those skilled in the art will appreciate that stock prices, trade volumes, related industry data, and other financial data constantly change and are updated in a stock exchange environment or market. As such, monitoring the status of stock the investor is interested in is an integral part of the stock investment process. At some point during the monitoring of the stock in the watch list, the user may desire to further evaluate investment in one or more particular stocks, stock derivatives, or other financial instruments such as options and futures. To perform such evaluation, the user may use various financial criteria and basic public parameters such as price per share of the target stocks, relevant statistics, price history, industry trends, company news, product releases, business mergers and acquisitions, and the like.

There are many such public financial parameters and criteria that have been used to evaluate the value of financial instruments and to determine the timing and level of investment. The basic public financial parameters may be obtained from a number of public sources, such as public financial databases, government publications, data repositories of public stock exchanges such as NYSE (New York Stock Exchange) or NASDAQ (National Association of Securities Dealers Automated Quotations), among others.

However, not all criteria and parameters have equal impact on the investment decision. Some criteria may be more important for long-term gain while others may be more important for short-term gains. For example, a small price drop in a stock in addition to indications of upcoming favorable product release news may be sufficient indicators that an investment in the stock may provide a desirable short-term gain, such as over a period of a few hours to a few weeks, when the stock price rises as a result of the product release news. The same criteria may not be sufficient indicators that the stock will perform well in terms of financial returns over the long-term, such as over a period of a few months to a few years. The level of importance of various parameters may be represented by a numerical weight when combining such parameters, as further described below.

Therefore, a systematic and objective analysis of a suitable combination of a variety of financial parameters and criteria may provide better indicators of successful investments with a desired level of return on investment, compared with ad-hoc and subjective evaluations of a few parameters. Often, the objective analysis of financial parameters calls for quantitative and reproducible numerical results, such as a performance or investment score on a selected scale, to provide a clear idea about the possibility and/or extent of success to an investor for investment decisions. Such scores further allow relative comparison between competing investment opportunities. For example, if an objective analysis results in a first score for the first opportunity and for a second score for the second opportunity, then a comparison of the first and the second score allows the investor to make a more informed and objective investment decision.

In various embodiments, the Investment Recommendation and Analysis System (IRAS) may generate a number of intermediate parameters based on the basic public parameters, and/or generate intermediate investment scores based on various basic and/or intermediate parameters. IRAS may also generate an overall score based on the intermediate scores and/or directly based on some or all of the financial parameters. The intermediate scores may include a Fundamentals Score, a Technical Score, an Analyst Score, and a Management Score (or Stock Earnings Score). The intermediate scores and/or the Overall Score generally indicate a relative financial, investment, or other value of the stock, stock derivative, and/or the intermediate parameters to which the scores apply. Those skilled in the art will appreciate that other parameter-based intermediate scores may be generated based on various combinations of various financial parameters without departing the spirit of the present disclosure. For example, a Market Score, a Trading Environment Score, and the like, may be generated as intermediate scores based on which the overall score may be calculated. In some embodiments, more than one overall score may be calculated based on the intermediate scores and/or directly based on financial parameters to be used in an investment analysis and/or recommendation. These intermediate and overall scores are further described below.

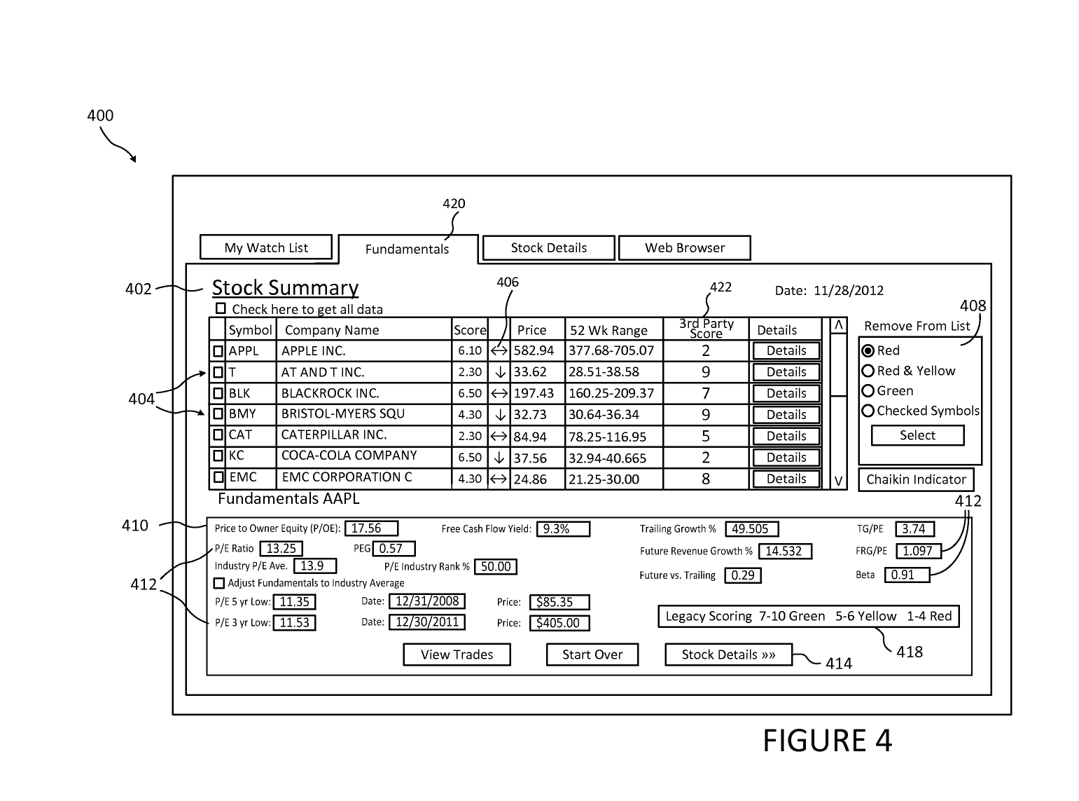

FIG. 4 shows the example GUI of FIG. 3 with parameters representing fundamental company stock data used in calculating investment scores. In various embodiments, fundamentals page 400 includes fundamentals tab 420, stock summary section 402, rows of stock summary data 404, visual indications 406 of current investment scores' statuses, third party score 422, filter options 408, data window 410, various financial parameters 412, Next button 414 to go to Stock Details page, and content color keys 418.

In various embodiments, IRAS may use several financial parameters for analysis, which parameters are obtained from external sources, such as stock exchange public databases, while other financial parameters are calculated based on the obtained parameters. The obtained parameters may include stock price, company revenue/earnings, P/E (Price to Earnings Ratio) Industry Rank, Industrial Average of P/E 5-year low and P/E 3-year low, various other industrial averages, and the like. The calculated parameters include Price to Owner Equity (P/OE), Free Cash Flow (FCF) Yield, Price to Earning ratio (P/E), P/E Growth (PEG), Trailing Growth (TG), TG to PE ratio (TG/PE), Future revenue Growth (FRG), FRG to P/E ratio (FRG/PE), FRG to TG ratio (FRG/TG), Price to Sales (P/S) ratio, and Beta. Those skilled in the art will appreciate that other financial parameters may be obtained and/or calculated without departing from the spirit and scope of the present disclosures. Each of these parameters are briefly described below.

In various embodiments, IRAS may generate and assign an overall score to a particular investment such as a selected stock, as well as assign individual scores for intermediate parameters used to generate the overall investment score. In various embodiments, the score may be a numerical score, an alphabetic score, a color-based score, a symbolic score, any combination of the above, or generally any other type of representation of the value of an investment or parameter on a predefined scale. The score generally indicates the favorable or unfavorable value of the investment, such as a particular company stock, or the intermediate parameter which is used to calculate the overall score. Those skilled in the art will appreciate that many types of scoring scales may be used without departing from the spirit of the present disclosure. For example, the scoring scale may be 1-10, A-F, 1-100, −5 to +5, red to green, and the like, with the best score being on the lower or the upper end of the scale, as defined by the system or based on user preferences. In various embodiments, several scales and/or scores may be combined. For example, a score of 2 on a scale of 1-10 may be considered a low score and be displayed in red color to emphasize the unfavorable value of the parameter or investment option. Similarly, a score of 1 on the scale of 1-5, with 1 being the highest score, may be displayed in green color to emphasize or highlight the favorable value of the score.

In various embodiments, different values or value ranges of financial parameters may be displayed in different colors or to provide additional visual information regarding such parameters. In some embodiments, color coding may be used to indicate whether a target stock, in which a user may be interested, is a good financial risk to purchase. For example, green color may be used to indicate various purchasing actions such as a “buy” recommendation, while a red color may be used to indicate a “do not buy” or a “sell” recommendation regarding the stock. Colors may also be used to indicate other information such as favorable or unfavorable status of the particular parameter. For example, on a scale of 1-10, with 10 being the highest/best score, scores above 7 may be displayed as green, 5 & 6 as yellow, and below 5 as red. This color coding provides a quick visual indication of symbols that pass the fundamental analysis. Those skilled in the art will appreciate that many other visual indications may be used to provide additional visual information to the user without departing from the spirit of the present disclosures. For example, different shapes, fonts, font sizes, underlining, bold text, video flashing, and the like may be used to indicate various statuses or information about particular parameters and/or the target stock, or indicate various recommended actions or transactions by the user, such as buy, hold, sell, watch, and the like.

In various embodiments, the values of these financial parameters may not be available or visible upon the display of the fundamentals page. The user may select, for example, by a mouse click, on the “Details” button in a target stock row to cause a software data component to obtain and/or load the data related to the selected stock row. In other embodiments, once the selected stock symbols are loaded, the software data component may automatically fetch and load internal, external, third party, or previously calculated and stored data for display in each stock row.

In various embodiments, investment data, such as information about stocks and other financial instruments like bonds, may be obtained one or more third parties. Such third party information may include scores or ratings of the selected financial instrument. For example, Birinyi Associates™, produces a score or rating for stocks based on money flow analysis within the stock market. Rather than looking at various financial ratios to estimate stock value, money flow analysis looks to what the market itself is signaling about a stock, sector, or market. This signal may be about interest rates, commodity prices, earnings expectations, future sales or takeover activity. Money flow analysis is based on how supply and demand relationships affect prices. The stock market operates as a closed system with all investors participating in a “zero-sum” interaction. This means that if one investor sells a number of stocks, another investor must buy the same number of stocks for the transaction to take place. Money Flow analysis seeks to measure the excess of demand over supply in a stock, sector, or market. It also seeks to establish whether trading is led by buyers (excess demand over supply) or by sellers (more supply than demand), and from this determine future price performance, and also some rating or score indicating the quality of the stock.

Such third party analysis, information, and scores may be used as one component by IRAS to determine the Overall Score, as further described below.

In various embodiments, one or more software components may be employed to implement or allow operation of the Investment Recommendation and Analysis System (IRAS) 300, shown in FIG. 3. The software components may include one or more each of user interface components, data collection component, financial data analysis components, database interface components, remote sever interface components, investment recommendation components, investment score calculation or generation components, and the like. Those skilled in the art will appreciate that functions performed by various software components may be consolidated and/or distributed between fewer or more components. Also, some functions may be performed by hardware and/or firmware for faster or more secure processing. IRAS and/or its software modules may correspond with App-1 210 to App-N 212, shown in FIG. 2 as loaded in the memory 206 of the computing device 200.

Price to Owner Equity (P/OE), is a compound variable or parameter, which takes into account a few individual variables or factors including price and owner equity. Price is the market price of the target stock of a company at the time of the calculation. Price may be divided by the Owners' Equity in the company to obtain the ratio P/OE. The owners' equity is defined as the levered cash flow of the company divided by the number of shares outstanding of the company. Levered cash flow is a calculation that is used by a company to help determine its profitability. Also called levered free cash flow, this calculation is a part of the business's cash flow report, and it provides potential investors an inside look at how effective and profitable the business is. In some embodiments, the user interface may present P/OE with color coded values. For example, if the P/OE has a value of 10, then a green score may be displayed, while a red score may be displayed if the value changes to 20.

Free Cash Flow Yield parameter is similar to the P/OE because it is related to the cash the company has on hand. The companies' operating cash (different from the levered cash flow) may be divided by the outstanding shares and then again divided by the price of the stock. In various embodiment, on a scale of 1-10, with 10 being the highest score, a value of over 10% is displayed as green (favorable) score. As this value moves down and approaches 7%, the number may turn red.

Price to Earning ratio (P/E) of the stock is a parameter family which IRAS may use, exclusively or non-exclusively, to derive various fundamental intermediate parameters, as further discussed below individually. Once the intermediate parameters are determined, an overall P/E score will be generated used to calculate the investment Fundamental score.

A particular stock P/E may be compared and evaluated against the industry average P/E. If the particular stock P/E is below the industry average, a higher score is assigned to the particular stock than if it was above the industry average. At about the industry average, the stock P/E is considered neutral and may be assigned a score of 8 on a 1-10 scale, with 10 being the highest score. As the particular stock's P/E rises above the industry average, its score will decrease. Conversely, as the score goes below the industry average, the score will increase. In various embodiments, a green number is displayed for a score above 7. If, for whatever reason, there is not an Industry Average P/E available for a particular industry, then the particular stock P/E is scored against the P/E of the S&P 500.

P/E Growth (PEG), This item is scored on its own. The PEG is the combination of the (Current Price)/(Yearly Earnings)/(Estimated Stock Growth). Because this variable takes all that into account, the industry scores this against a mark of 1.0. In the Legacy scoring system, we will do the same on a sliding scale with a score of 7 being given to a PEG of 1.0. As the value drops lower than 1, more points will be given and as it moves higher than 1, points will be taken away.

P/E Industry Rank parameter may obtained from various external sources, such as various databases or services associated with different stock exchanges like NYSE (New York Stock Exchange) or NASDAQ (National Association of Securities Dealers Automated Quotations). The industry percentage rank is generally represented as a fraction, such as “ 5/25”. For calculation purposes this fraction may be converted to a decimal number. In various embodiments, with a value of 100% corresponding to the highest score, an investment score may be assigned on a sliding scale of 1 to 10. The score is equal to this percentage divided by 10. For example, a 70% rank will be assigned a score of 7.

Trailing Growth (TG), is a type of revenue growth which is a part of IRAS' Fundamental Score calculation. A number of calculations may be performed including three components, described later. A trailing revenue growth and a future expected revenue growth (described below) may be calculated. TG and future expected revenue growth are compared to determine the growth trend for the stock and/or the company. TG may be calculated based on several financial parameters including “Net Income” and “Total Revenue” of the company, as follows:

Trailing Growth=(Net Income*A)+(Total Revenue*B) (1)

Where A and B are constant multipliers and may have values such as 0.3 and 0.7, respectively.

TG to PE ratio (TG/PE) may be calculated once the Trailing Growth is obtained:

TG/PE=(Trailing Growth)/(P/E of the stock) (2)

The result of this calculation (TG/PE) may be scored as an intermediate value. A value of less than 1 is desirable as it indicates that the growth in the past was slower, or less than the P/E. A score of 1 is considered neutral and may be given a score of 8 on a scale of 1-10. As the ratio rises above 1, the score will decrease. And as the score goes below 1, the score will increase. A green number is displayed for a score above 7.

Future Revenue Growth (FRG) provides an indication of the next year's projected Revenue. The next year's revenue estimate may be reduced by the current year revenue to calculate a percent increase from last year. This result may be scored the same way as the trailing growth variable.

FRG to P/E ratio (FRG/PE) may be calculated using the current P/E:

FRG/PE=(Future Revenue Growth)/(P/E of the stock) (3)

In the case of future growth expectations, it is desirable to have a growth that is above the current P/E. Thus, a value of greater than 1 is desirable as it indicates that the growth in the future will be faster, or more than the P/E. A score of 1 is considered neutral and may be given a score of 8 on a scale of 1-10. As the ratio falls below 1, the score will decrease. And as the score goes above 1, the score will increase. A green number may be displayed for a score above 7.

FRG to TG ratio (FRG/TG) is a parameter which indicates revenue growth trend and may be calculated by dividing the future by the trailing growth trends to get a percent difference, that is, to indicate how much more will the revenue likely grow the next year than it did this year. It is a marginal growth rate of the revenue. This is useful because the investor generally desires the future growth trend to be higher than the past. A ration of over 1.0 indicates such growth.

FRG/TG=Future Revenue Growth/Trailing revenue Growth (4)

Price-to-Sales (P/S) ratio is used to valuate stocks. It is calculated by dividing the per-share stock price by the per-share revenue in the most recent year or the last 12 months.

Beta is a measure of a stock's volatility in relation to the market. By definition, the market has a beta of 1.0, and individual stocks are ranked according to how much they deviate from the market. A stock that swings more than the market over time has a beta above 1.0. If a stock moves less than the market, the stock's beta is less than 1.0. High-beta stocks are considered to be riskier but provide a potential for higher returns, while low-beta stocks pose less risk but also lower returns. Beta is a key component for the Capital Asset Pricing Model (CAPM), which is used to calculate cost of equity. Cost of capital represents the discount rate used to arrive at the present value of a company's future cash flows. All things being equal, the higher a company's beta is, the higher its cost of capital discount rate. The higher the discount rate, the lower the present value placed on the company's future cash flows. In this way, beta may impact a company's share valuation.

Industrial Average of P/E 5-year low and P/E 3-year low may also be useful in scoring the parameters and/or evaluating the company because IRAS uses the P/E parameter of a stock in calculating several of the intermediate parameters and a comparison to past values of P/E provides an additional check on the health of the company.

After calculating and scoring the intermediate parameters, the Fundamental Score may be calculated as a linear combination of other parameters as follows in equation 5a:

$$Fundamental Score = ( ( P \text{/} E Score ) * C 1 ) + ( ( P \text{/} E Rank Score ) * C 2 ) + ( ( PEG Score ) * C 3 ) + ( ( Trailing Growth Score ) * C 4 ) + ( ( Future Growth Score ) * C 5 ) + ( ( FRG \text{/} TG ) * C 6 ) + ( ( P \text{/} OE Score ) * C 7 ) \qquad ( 5 a )$$

Where “*” is the multiplication operation, and C1-C7 are numerical weighting constants such as 0.2, 0.1, 0.2, 0.1, 0.1, 0.1, 0.2, respectively, for a scoring scale of 1-10, with 10 being the highest/best score. Those skilled in the art will appreciate that this scale may converted to any other scale by changing the constants C1-C7, or mapping the resulting Fundamental Score to another scale via a table or a mathematical process.

Alternatively, the Fundamental Score may calculated according to the following equation 5b:

$$Fundamental Score = ( ( ( PE + PE Rank + PEG ) / 3 ) * C 10 ) + ( Free Cash Flow Yield * C 11 ) + ( ( ( Trailing Growth + Future Growth + FRG \text{/} TG ) / 3 ) * C 12 ) + ( ( Price to Owners Equity ) * C 13 ) \qquad ( 5 b )$$

Where “*” is the multiplication operation, and C10-C13 are numerical weighting constants such as 0.3, 0.051, 0.25, 0.4, respectively, for a scoring scale of 1-10, with 10 being the highest/best score. Those skilled in the art will appreciate that this scale may converted to any other scale by changing the constants C10-C13, or mapping the resulting Fundamental Score to another scale via a table or a mathematical process.

Those skilled in the art will appreciate that the Fundamental Score may be calculated based on the above basic, calculated, and intermediate financial parameters using other mathematical formulas or other combinations of such parameters, without departing from the spirit of the disclosure. For example, the fewer or more of the parameters may be used; some of the parameters may be raised to a numerical power to increase its influence on the Fundamental Score, the difference of two parameters may be used in the calculations; the percent change in some parameters over some period may be used; and the like.

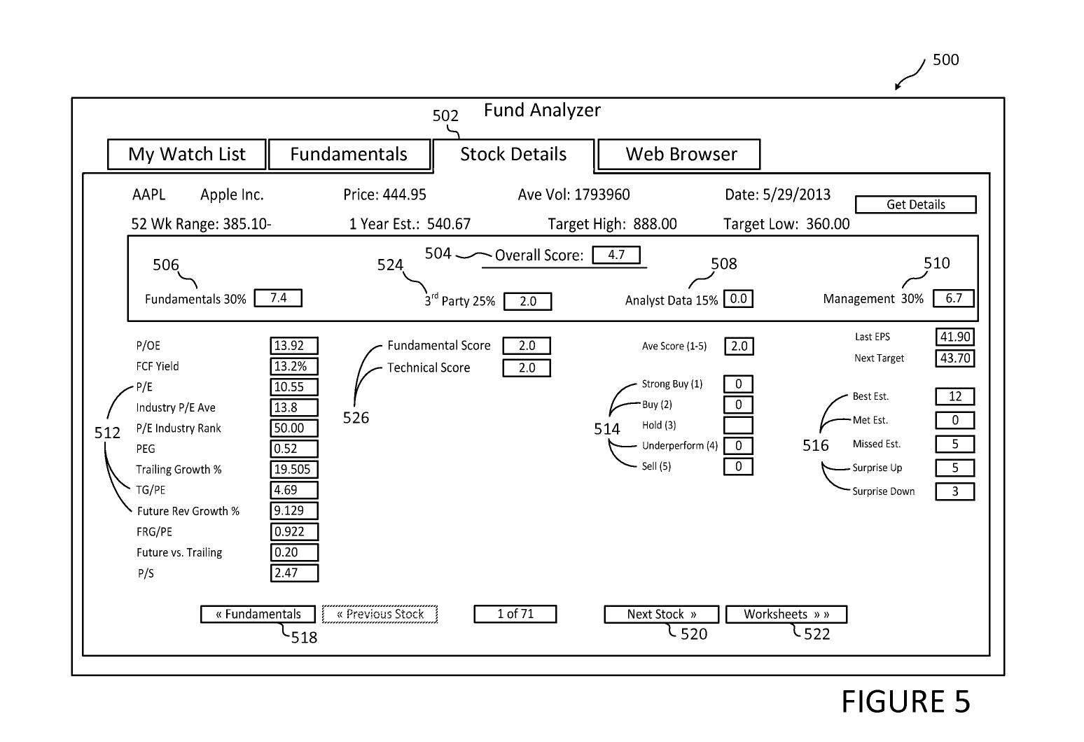

FIG. 5 shows an example stock details page with summary of parameters used to calculate the investment score for a selected stock. In various embodiments, stock details screen 500 includes generated scores. The generated scores include Overall Score 504, Fundamental Score 506, Analyst Score 508, and Management Score 510 (also termed as Stock Earnings Score). The stock details screen 500 further includes listing of obtained and generated intermediate financial parameters 512, Analyst data 514, management data 516, Fundamentals screen button 518, Next Stock button 520, and Worksheet button 522.

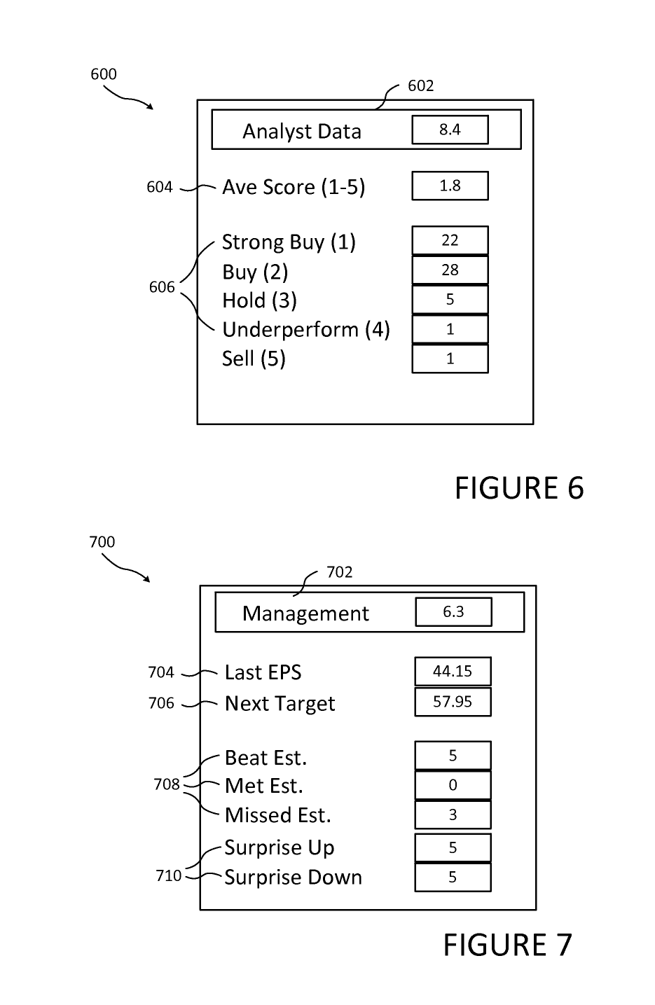

In various embodiments, stock details screen provides a detailed list of all relevant parameters, and their corresponding values and/or scores, used in calculating the Overall Score for a selected stock. For example, FIG. 5 shows an example AAPL stock (for Apple, Inc.) and some general financial information such as price, average volume, date 52-week range, and the like. Additionally, the parameter values specific to this stock are summarized in three categories listed in columns of Fundamentals, Analyst Data, and Management Data. The parameters include the ones described above with respect to FIG. 4, such as P/E, PEG, TG/PE, and the like. The parameters listed in the Analyst and Management Data columns are further described below with respect to FIGS. 6 and 7.

Those skilled in the art will appreciate that more, fewer, or different financial parameters or categories may be used to calculate the Overall Score, without departing from the spirit of the present disclosure. For example, Beta and other derived parameters or ratios of parameters may be used in the intermediate or overall scores' calculations. Additionally, a Technical category may be added including Beta, described above, 10-Year US government note, the VIX (Volatility IndeX) indicator, and 50 and 200 Simple Moving Averages (SMA).

The 10-Year US government note may be an indication of the market sentiment. It is generally understood by traders that as the value/price of bonds move one way, the stocks will move the other way. That is, if the price of bonds go up, the price of stocks generally go down, and vice versa. In various embodiments, IRAS may examine the daily change of this note and score positive if is moving down.

The VIX (Volatility IndeX) is an indicator, which may be used in a similar way as the 10-Year Note. Just as the value of 10-Year note moves in an opposite direction with respect to stocks, so does the VIX. This will measure the volatility of the index and thus the market. If it is moving one way, the market is moving the other. Here we will again measure the daily change. If the VIX is moving down, a point will be scored.

The 50 and 200 SMA may be used to determine a general direction of the stock. In various embodiments, on a scale of 1-10, with 10 being the highest score, the two moving averages may be compared against each other and then against the target stock price. If the 200 SMA is greater than the target stock price, an additional point is scored. In addition, if the 50 SMA is also greater than the 200 SMA, another point is scored. These relative values may be considered a bullish signal and may be scored as such to indicate higher tolerance for risk. However, if the 200 SMA is below the target stock price and the 50 SMA is even below the 200 SMA, then no additional points scored.

The Technical Score may be calculated based on one or more of the above technical financial parameters, and in turn, the Technical Score may be used to calculate the IRAS Overall Score.

In various embodiments, the user interface controls include Fundamentals button 518, Next Stock button 520, and Worksheet button 522. These controls or buttons are used to quickly navigate the interface to different pages and/or stages of the process from the current page. Those skilled in the art will appreciate that these controls may be implemented as “Next,” “Previous,” “Page N,” where N is a page number, and the like.

FIG. 6 shows an example stock analyst score obtained based on analysis results of multiple financial analysts. In various embodiments, Analyst Data page 600 includes Analyst Score 602, average analyst score 604, and analyst recommended actions 606.

For a selected stock, various industry analysts may rate the stock on a particular scale, such as 1-5, with 1 being the highest rating, and recommend an action corresponding to their ratings. For example, a particular stock may be reviewed by a number of analysts and result in the numbers shown in FIG. 6, where 22 analysts have rated the stock as 1 and recommend “Strong Buy” action, while 28 analysts have rated the stock as 2 and recommend a “Buy” action, and so on. An appropriate software component of IRAS, such as the data collection software module, may collect the analysts' data from public databases or services for IRAS' analysis and calculation of Analysts Score.

In various embodiments, the investment score calculation software module of IRAS may calculate the average analysts' score based on their own particular scale, such as 1-5 (1 being the highest score), and then convert it to IRAS' scale, such as an inverted 1-10 scale (10 being the highest score). For example for the data shown in the table of FIG. 6, the average of all analyst ratings is 1.8 on the 1-5 scale, which maps to 8.4 on the inverted 1-10 scale.

FIG. 7 shows the example management score obtained based on results of Estimated Per Share (EPS) projections. In various embodiments, Management Data page 700 includes Management Score 702 (also known as Stock Earnings Score), last Earnings Per Share (EPS) 704, next target EPS 706, rating of the EPS estimates 708, and surprise factors 710, such as Surprise up and Surprise Down.

One of the factors considered by IRAS to generate the Overall Score is the evaluation of the strength of a management team for the company associated with the target investment stock. One technique for management evaluation is to track the last N quarters of the company's earnings, for example, the last 5 to 10 quarters. Those skilled in the art will appreciate that the earnings may be quarterly, biannually, annually, or over any other period of time, without departing from the spirit of the present disclosure.

Each time the company earnings are announced, a next earnings goal, in terms of EPS, may be set for the company to meet. IRAS may consider the actual earnings versus the earning goals to establish a trend. If the company beats the earnings goal, a positive score is given, otherwise a negative score is recorded. Based on this trend a Management Score may be assigned based on some scale, such as 1-10, with 10 being the highest score. For example, for a total of 10 quarter reported earnings of the stock, points may be given for the number of times the earnings beat the earnings estimates set as goals previously. If the earnings beat the estimates 7 times out of 10, then a 70% success rate is identified and a score of 7 is given. With reference to FIG. 7, another illustrative example shows the target company beat the estimate 5 times and failed to meet expected earnings 3 times, for a total of 8 earning periods. The given Management Score is: 63% calculated as 5/8=6.3, out of 10.

In various embodiments, the Surprise Up and Surprise Down factors may be considered, in addition to the EPS ratings. For example, the company exceeded the earnings expectation by a wide margin, it may be given additional bonus points, and if it failed to meet the expected earnings, then additional points are subtracted to calculate the Management Score.

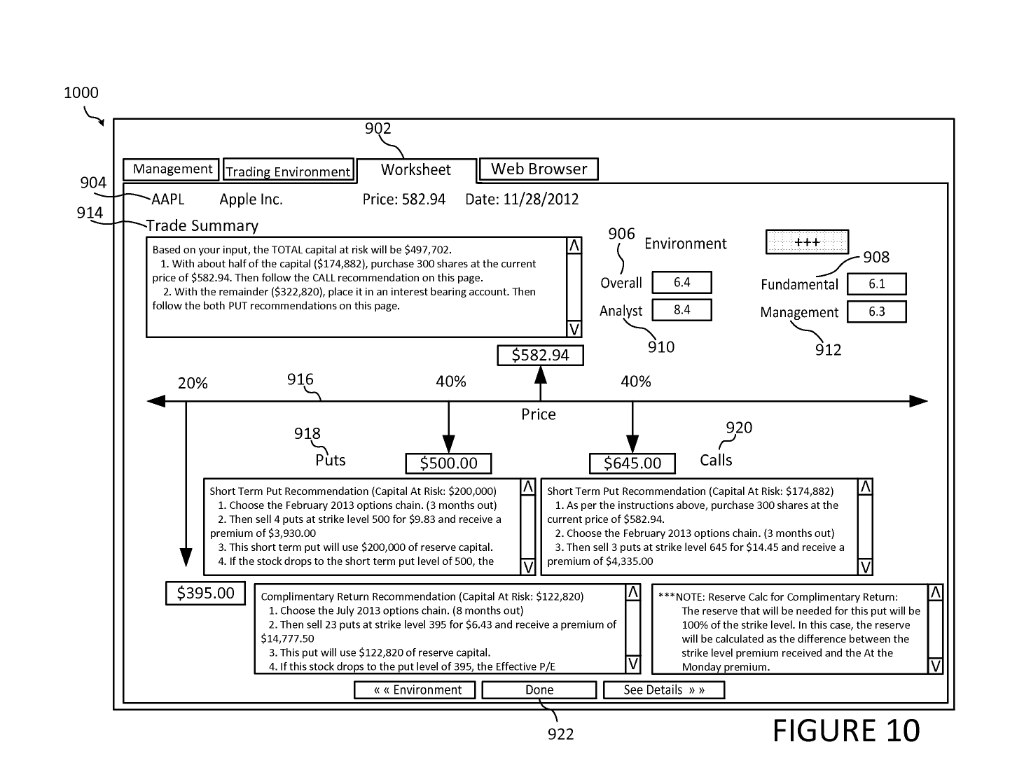

In various embodiments, once the score for a particular stock is determined as described above, the investor may decide, based on the Overall Score, to proceed with investing in the particular stock. At this point, the IRAS may recommend an investment strategy with or without the aid of a human analyst, as further described with respect to FIG. 10.

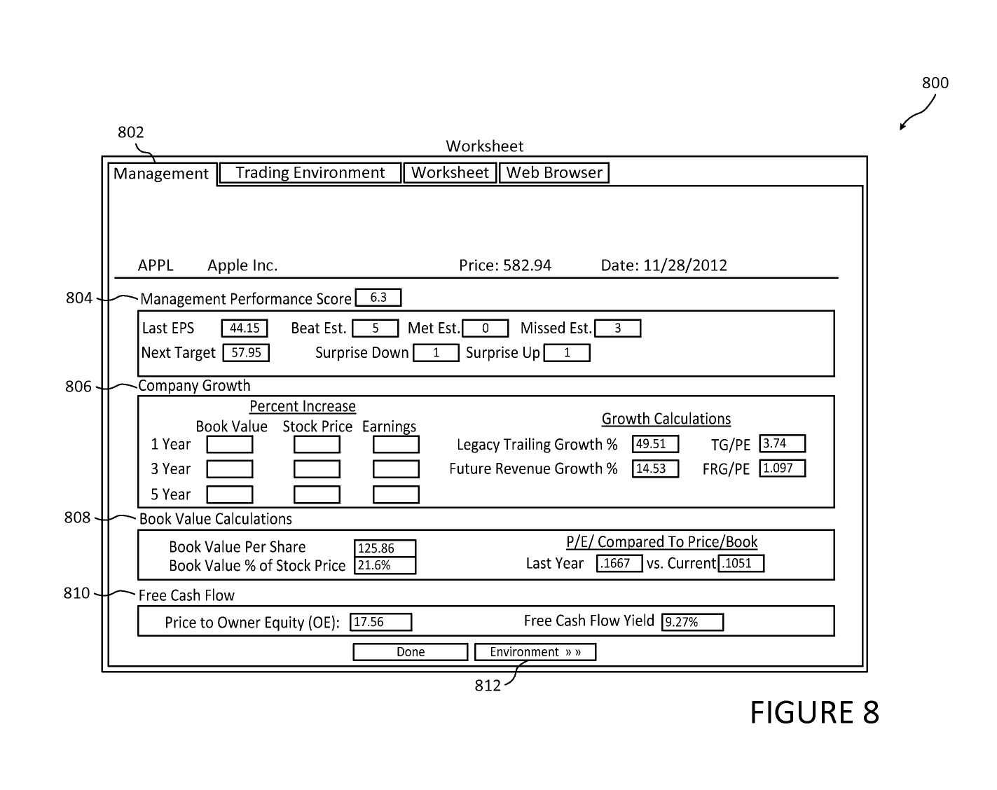

FIG. 8 shows an example management performance page with some of the parameters used to evaluate the performance of management of a selected company. In various embodiments, management performance page 800 includes management performance ratings section 804, company growth parameters 806, book value calculations 808, free cash flow 810, and user interface control 812 for navigating to other web pages.

The management performance rating parameters were described above with respect to FIG. 7.

In various embodiments, evaluation of management strength may be further based on company growth as measured by increases (or decreases) in various prices of the company, such as book value, stock price, and earnings over some pre-defined periods of time, such as the last 1, 3, or 5 years. The growth may be quantified using TG (Trailing Growth), FRG (Future Revenue Growth), P/E, and their ratios over the pre-defined periods of time.

The book value of a company is its accounting value according to the company's accounting books. It may be used in at least two ways: one, it is the total value of the company's assets that shareholders would theoretically receive if a company were liquidated, and two, by being compared to the company's market value, the book value is an indicator of whether the company's stock is currently under- or overpriced. Book value may be used in conjunction with share value to calculate book value per share and book value as a percentage of stock price. It may further be compared with P/E over a predefined period such as 1, 3, or 5 years.

Free cash flow is a measure of financial performance calculated as operating cash flow minus capital expenditures. Free cash flow represents the cash that a company is able to generate after allocating the money needed to maintain its asset base. Free cash flow allows a company to pursue opportunities as developing new products, making acquisitions, pay dividends, and reduce debt. As such free cash flow and P/E may be used in combination with other parameters to assess the performance of the company and its management team.

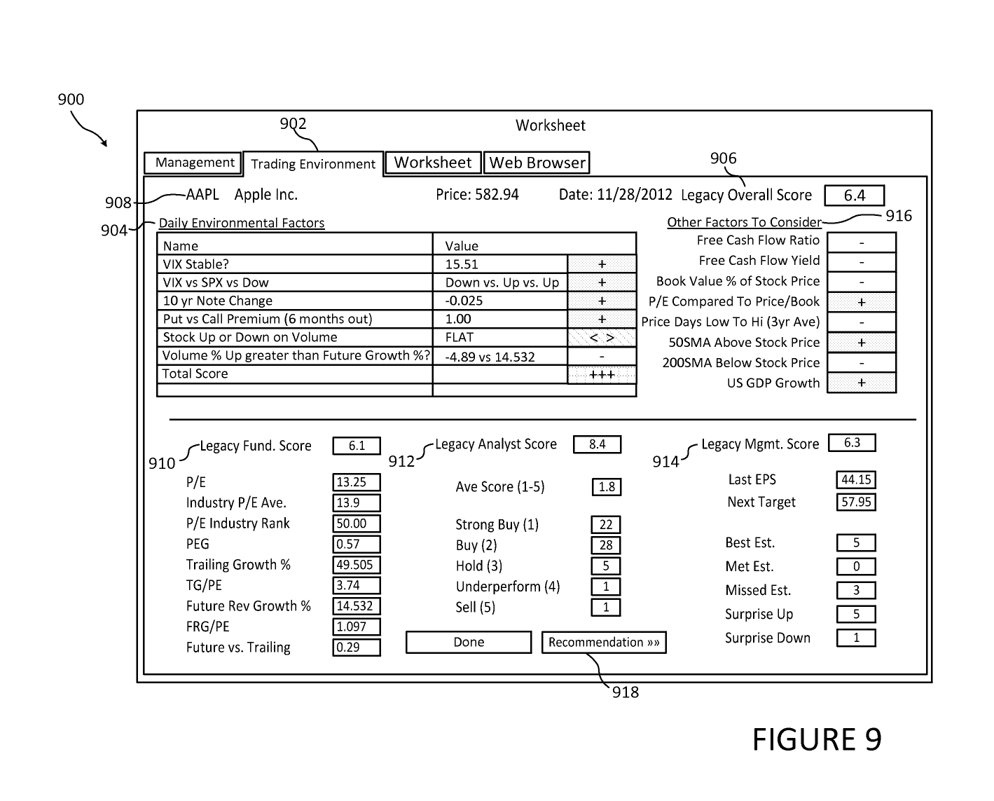

FIG. 9 shows an example trading environment page with summary of industry factors relevant to the overall investment score for the selected company stock. In various embodiments, the trading environment page 900 includes trading environment tab 902, daily environmental factors 904, Overall Score 906, company stock identifier or ticker 908, Fundamental Score and related parameters 910, Analyst Score and related parameters 912, Management Score and related parameters 914, and other factors to consider 916.

In various embodiments, trading environment may have a bearing on the future of a selected stock. Various trading environment parameters may indicate the health and/or trend of the market with respect to a particular stock or industry. The trading environment may be taken into account for a final recommendation on one or more stock purchases, sales, or other transactions, in addition to the Overall Score, itself being based on several intermediate scores such as Fundamentals Score, Analyst Score, Management Score, and Technical Score.

In various embodiments, the trading environment parameters may be rated based on a + (plus) or − (minus) rating, the + indicating that the corresponding parameter is favorable while the − indicating an unfavorable condition. Those skilled in the art will appreciate that many other kinds of rating may be used for these parameters without departing from the spirit of the present disclosure. For example, letter grades, 1-100, or other similar scales may be used to rate the trading environment parameters.

The daily or short-term trading environmental factors or parameters may include VIX stability, changes in VIX versus changes in other exchanges such as SPX and Dow Jones Industrial, 10-year Note change, put versus call, stock volume, comparison of stock volume change to FRG, and the like. A total score may be obtained for these parameters by adding the pluses and minuses to have a rating including a number of + or −, such as “+++” or “−−.”

Like daily parameters, longer term additional factors may be considered to evaluate market conditions. These long-term environmental parameters may include free cash flow ration, free cash flow yield, book value percentage of stock, comparison of P/E to Stock Price/Book Value, Price days Low to High averaged over a predefined period of time, 50 SMA above stock price, 200 SMA below stock price, US GDP growth, and the like. These long-term parameters may also be rated in the same or different manner as the daily environmental factors to further characterize the market condition.

In various embodiments, the intermediate scores such as the Fundamentals Score, Analyst Score, Management Score, and Technical Score and their respective parameters, based on which each of the intermediate scores was calculated, may also be displayed on the trading environment page for easy reference. In turn, the Overall Score 906 may be calculated as a linear combination of two or more intermediate scores as follows:

Overall Score=((Fundamentals Score*K1)+(Management Score*K2)+(Analyst Score*K3)+(Technical Score*K4)) (6a)

Where “*” is the multiplication operation, and K1, K2, K3, and K4 are numerical constants used to assign a weight to their respective intermediate scores to determine how much influence each intermediate score has on the Overall Score. Example values for K1-K4 variables are 0.5, 0.4, 0.1, and 0.0.

Alternatively, the Overall Score may be calculated according to the equation 6b below:

$$Overall Score = ( Third Party Score * K 10 ) + ( Management Score * K 11 ) + ( Analyst Score * K 12 ) + ( Fundamental Score ) * K 13 ) \qquad ( 6 b )$$

Where “*” is the multiplication operation, and K10, K11, K12, and K13 are numerical constants used to assign a weight to their respective intermediate scores to determine how much influence each intermediate score has on the Overall Score. Example values for K10-K13 variables are 0.25, 0.3, 0.15, and 0.3. In various embodiments, the Third Party Score may be the Birinyi score from Birinyi Associates, Inc.™.

Those skilled in the art will appreciate that the intermediate scores may be combined differently to obtain the Overall Score. For example, one or more of the intermediate scores may be raised to a numerical power, may be multiplied by another intermediate score, or other be combined according to other mathematical formulations depending on the meaning of the score and the scale on which they are evaluated.

FIG. 10 shows an example worksheet including detailed investment recommendations. In various embodiments, investment recommendation worksheet 1000, which is the culmination of all previous intermediate stages, intermediate parameters, and trading environment factors, is used to create a final investment recommendation to the investor. In various embodiments, the investment recommendation worksheet 1000 includes recommendation worksheet tab 902, company stock ticker 904, Overall Score 906, intermediate Fundamental Score 908, intermediate Analyst Score 910, intermediate Management Score 912, recommended trade summary 914, detailed investment recommendation categories 916 having Puts recommendations 918 and Calls recommendation 920, and user interface button 922.

In various embodiments, an investment strategy is recommended by the IRAS. In some embodiments, the IRAS recommendation is generated based on automated algorithms without the aid of a human analyst, while in other embodiments, the IRAS recommendation is aided or augmented by a human analyst. In various embodiments, the IRAS recommendation includes division of the total investment money into several investment parts or budgets, each part being the same or a different percentage of the total investment money, and each part allocated for a particular purpose in the investment process. In some embodiments, the money is divided into three separate parts, one part for purchasing the target stock which was scored by IRAS against which covered Calls may be written. The other two parts of the capital may be used to cover two additional Put contracts. The first Put contract will be the closest (as measured in dollars) to the market price of the stock and have the shortest expiration date. While the second Put may be the farthest away (in dollars) from the market price with the greatest number of days to expiration. That is, IRAS may recommend some portion, such as 40%, of the investment money be allocated for the stock in which the Fundamental Score is strong with the correct technical market timing. The investor may then write covered calls against the newly purchased stock. While the remaining portion, such as 60%, may be allocated to cover two Put options that the investor will write to obtain the stock at a lower price than the current market value.

Those skilled in the art recognize that the Call option for a stock gives the owner of the option the right to buy the stock from the seller of the Call option at a specific price on or before a specified date; and a Put option gives the option owner the right to sell the stock to the seller of the Put option at a specific price, on or before a specified date. Thus, an option buyer may profit from Calls if the stock price goes higher than the Call option price, and profit from Puts if the stock price goes lower than the Put option price.

Dividing the total investment money into parts or budgets for buying the stock, the Call options, and the Put options in the right proportions may increase the investor's profits while lowering his risks. Stock prices may go up or down creating profit or loss for the investor. Depending on market conditions and likelihood of stock price movement in a particular direction, up or down, Call options may increase profits if target stock price drops, while Put options increase profits if target stock price rises. To achieve enhanced profits or reduce losses, the Call and Put option prices and termination dates need to be set properly. These option parameters are set based, at least partially, on information obtained from the investor.

In determining the Call and Put prices and termination dates, some information are collected from the investor. This information may be the answers to questions asked from the investor, such as what price the investor is willing to invest in the stock if he has a number of this stock or if he doesn't, what ARR (Annualized Return Rate) he expects, and what stock growth he expects, further described below. Depending on the investor's answers, the calculations and recommendations may vary.

In various embodiments, the questions asked from the investor may include request for one or more of the following information. Each of the information items collected may have a default value. The default values shown are for illustrative purposes only and may be any other reasonable value for the given item.
Expected Growth of the stock on annual basis; Default=10%
Amount of Capital for this investment; Default=$500,000
Short Term options of the stock to be sold and amount of reserve cash in the account
Annualized Rate of Return (ARR); Default=10%
Period of time investor considers as short-term option sell transaction
Period of time investor considers as long-term option sell transaction

In various embodiments, if the investor does not have any of the target stock, then the recommendation may include several financial components, which may be to take a first portion of the total investment budget or money, such as 40%, and purchase the stock at the current market price. Then another portion of the investment, such as 60%, may be set aside to cover the Put options to be sold later. Next, a covered Call option on the stock that was just purchased may be sold. Those skilled in the art will appreciate that other percentage of the investment money may be used for these purposes, such as 60% and 40%, depending on market conditions and financial parameters discussed above.

The Put and covered Call option strike prices may be calculated as follows:
1. Obtain the expected stock growth from the investor. This percentage may then be multiplied by the current market price to get the covered Call strike level (above the stock price). The recommended investment may generate the expected stock growth if the stock moves from the Current Market Price to the Covered Call level price. So, for example, if the Current Market Price is $30 and the Call Strike (or target) Level is $40 and the stock moves from $30 to $40, the investor can make $10 per share if the covered Call is allowed to be exercised. For a fundamentally strong stock, based on the Fundamental Score, IRAS may recommend that the investor buy back the covered Call and move the option further out of the money. This way the investor may participate in the appreciation of the stock.
2. Both the short term (for example, 1 to 6 months, or other predefined short-term period) Put and long term (for example, over 6 months, or other predefined long-term period) Put options may then be calculated. To arrive at the two strike prices (target prices), three different strike prices may be calculated. The closest strike price of the three will be the short term Put (with the least number of days to expiration) and the farthest strike price of the three will be the long term (or complimentary) Put.
   2a. The specific calculations are as follows:
      1) (N-year Average PE of the stock/Present PE)*Current Market Price (where N may be 5 years, for example)
      2) N year price range—Current Market Price
         a. Range is defined as the amount (in dollars) from high to low in a given year
      3) N year band—Current Market Price
         a. Band is conventionally defined as the stock price on January 1 minus the stock price on December 31 of the same year. Those skilled in the art will appreciate that the band may be defined based on different dates without departing from the spirit of the present disclosure.
3. After the Strike prices are determined, the investor is asked to choose a Short Term month (for example, from 1 to 6 months) and a Long Term month (for example, anything over 6 months).
4. These calculations may be presented to the investor via the user interface for his review and decision. If the positions found do not meet the investor's criteria, then a new set of criteria, such as desired return level, may be considered and new Put and Call option Strike levels may be calculated as outlined above.

In various embodiments, if the investor has some of the target stock already but is interested in adjusting his position with regard to the target stock, such as improving ownership cost, augmenting his investment with Call and Put options, and the like, then a procedure similar to the above non-owner case, where the investor does not have any of the target stock, is followed with some differences as noted below.

The calculations for this case is similar to the above non-owner case, except that there will be no Call option recommendation since the target stock is already owned and will not be purchased. In this case, the investor may use Put options to improve his position. So, in this case a covered Call option may be recommended. IRAS may not recommend a Put position with no cash to back it up. The calculations are the same as in the first example for a Call.

As an example and with continued reference to FIG. 10, in the IRAS trading system multiple trades, transactions, and positions may be recommended, such as a stock purchase with 40% of the capital, a covered Call option sale against the newly purchased stock, and two Put options, one short-term and one long-term. The short term Put option may be written against 40% of the cash in reserve. The remaining 20% of the capital may be allocated to the long-term Put option. Those skilled in the art will appreciate that in some cases the investor may not be able to obtain the exact pricing for the stock and options that was listed by IRAS. This is mainly due to market movement. In this screen, the investor will input the actual values he gets from his trading platform. The numbers displayed are what has been calculated by the system, but can be changed.

In this screen, IRAS may display each option trade in detail in a graphical details box or frame. Detailed information may include the strike price of the options displayed over each details box. Inside each details box may be information indicating how much capital is at risk, how many options to sell, which month and year, how much premium will be brought in, and what price to pay. The P/E may also be recalculated at this price level and compared against historic highs and lows. If these numbers fit the trading plan of the investor, he can click the See Details button to further analyze the returns.

In various embodiments, with reference to FIG. 4, an “Adjust Fundamentals to Industry Average” button or checkbox may be provided. By selecting this button, an adjustment software module in IRAS may provide a “What If” scenario. The IRAS system uses the Price to Earnings Ratio (P/E) parameter in performing some of its calculations. Any movement or change in this variable may affect the Fundamental Score of the stock. When this button is selected, IRAS adjusts the P/E value to the industry average and re-calculates the Fundamental Score. This score may provide the investor with an indication of what happens to the stock price if it migrates back to the industry average. Such What-If scenarios are helpful in comparing different decisions and outcomes. More specifically, changing the P/E parameter value may affect the following variables and calculations:

Stock Price

PEG

Trailing Growth/PE

Future Growth/PE

In various embodiments, when the adjustment option button is selected, a new “What-If” results dialog box may appear to display the recalculated items. For example, a new value for the Fundamental Score may be shown as well as new values for the above mentioned variables. Other information may also be displayed in the What-If dialog box, such as the differences in values, corresponding color-coded scores based on increased or decreased values, and the like.

In various embodiments, additional facilities may be provided by IRAS to assist in managing the investor's trades and transactions. For example, a “Manage My trades” page or section may be presented in the IRAS' user interface to allow management of trades. A listing of all the executed trades (for example, both Puts and Calls) may be presented to the investor. One of the functions of this page may be to take a selected particular trade and programmatically determine if the movement of the trade option, in terms of dollars or other parameters, going in a direction that will benefit or harm the investor, and present such information to the investor. Based on such presented information, the investor may take various actions such as canceling or changing the selected trade appropriately.

It will be understood that the computer program instructions may be executed by a processor to cause a series of operational steps to be performed by the processor to produce a computer implemented process such that the instructions, which execute on the processor to provide steps for implementing the actions specified in the disclosed processes and methods. The computer program instructions may also cause at least some of the operational steps to be performed in parallel. Moreover, some of the steps may also be performed across more than one processor, such as might arise in a multi-processor computer system. In addition, one or more steps or combinations of steps may also be performed concurrently with other steps or combinations of steps, or even in a different sequence than described without departing from the scope or spirit of the disclosure.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

1. An investment recommendation system comprising:
a software component, configured to process financial data, that when executed on a computing device causes the computing device to:
obtain a plurality of basic financial parameters;
generate a plurality of intermediate parameters based on the basic financial parameters;
generate a plurality of intermediate scores based on the associated intermediate parameters;
generate an overall investment score based on the plurality of intermediate scores; and
generate an investment recommendation based on at least the overall investment score.

2. The investment recommendation system of claim 1, wherein the basic financial parameters are obtained from public databases.

3. The investment recommendation system of claim 1, wherein the obtained basic financial parameters include at least one of stock price, company earnings, P/E (Price to Earnings Ratio) Industry Rank, Industrial Average of P/E 5-year low and P/E 3-year low.

4. The investment recommendation system of claim 1, wherein the plurality of the intermediate scores are displayed in different colors depending on the corresponding values of each of the plurality of intermediate scores.

5. The investment recommendation system of claim 1, wherein intermediate parameters include at least one of Price to Owner Equity (P/OE), Free Cash Flow Yield, Price to Earning ratio (P/E), P/E Growth (PEG), P/E Industry Rank, Trailing Growth (TG), TG to PE ratio (TG/PE), Future revenue Growth (FRG), FRG to P/E ratio (FRG/PE), FRG to TG ratio (FRG/TG), and Beta.

6. The investment recommendation system of claim 5, wherein the plurality of the intermediate scores includes Fundamentals Score, Technical Score, Analyst Score, and Management Score, the intermediate scores indicating a relative financial value of a stock.

7. The investment recommendation system of claim 6, wherein Fundamentals Score calculated based on the following equation:
$$Fundamental Score = ( ( ( P \text{/} E + P \text{/} E Industry Rank + PEG ) / 3 ) * C 10 ) + ( Free Cash Flow Yield * C 11 ) + ( ( ( Trailing Growth + Future Growth + FRG \text{/} TG ) / 3 ) * C 12 ) + ( ( Price to Owners Equity ) * C 13 ) ;$$
wherein C10, C11, C12, and C13 are numerical constants.

8. The investment recommendation system of claim 7, wherein the overall investment score is calculated based on the following equation:
$$Overall Investment Score = ( Birinyi Score * K 10 ) + ( Management Score * K 11 ) + ( Analyst Score * K 12 ) + ( Fundamental Score ) * K 13 ) ;$$
wherein K10, K11, K12, and K13 are numerical constants.

9. The investment recommendation system of claim 1, wherein the investment recommendation comprises taking a first percentage of a total investment budget and invest it in stock purchase, taking a second percentage of the total investment budget and invest it in Put options for the stock, and taking a third percentage of the total investment budget and invest it in Call options for the stock.

10. A method of generating a recommendation for investment, the method comprising:
obtaining a plurality of basic financial parameters using a software component configured to process financial data when executed on a computing device;
generating a plurality of intermediate parameters based on the basic financial parameters using the software component;
generating a plurality of intermediate scores based on the associated intermediate parameters using the software component;
generating an overall investment score based on the plurality of intermediate scores using the software component; and
generating an investment recommendation based on at least the overall investment score using the software component.

11. The method of claim 10, wherein the plurality of basic financial parameters includes at least one of stock price, company earnings, P/E (Price to Earnings Ratio) Industry Rank, Industrial Average of P/E 5-year low and P/E 3-year low.

12. The method of claim 10, wherein the plurality of intermediate parameters include at least one of Price to Owner Equity (P/OE), Free Cash Flow Yield, Price to Earning ratio (P/E), P/E Growth (PEG), Trailing Growth (TG), TG to PE ratio (TG/PE), Future revenue Growth (FRG), FRG to P/E ratio (FRG/PE), P/E Industry Rank, FRG to TG ratio (FRG/TG), and Beta.

13. The method of claim 12, wherein the plurality of the intermediate scores and the overall investment score are displayed in different colors depending on the corresponding values of each of the plurality of intermediate scores.

14. The method of claim 10, wherein the plurality of the intermediate scores includes Fundamentals Score, Technical Score, Analyst Score, and Management Score.

15. The method of claim 14, wherein the overall investment score is calculated based on the following equation:
$$Overall Investment Score = ( Birinyi Score * K 10 ) + ( Management Score * K 11 ) + ( Analyst Score * K 12 ) + ( Fundamental Score ) * K 13 ) ;$$
wherein K10, K11, K12, and K13 are numerical constants.

16. A method of evaluating company stock, the method comprising:
selecting a particular company stock;
obtaining a plurality of basic financial parameters associated with the particular company stock using a software component configured to process financial data when executed on a computing device;
generating a plurality of intermediate parameters based on the basic financial parameters using the software component;
generating a plurality of intermediate scores based on the associated intermediate parameters using the software component; and
generating an overall investment score based on the plurality of intermediate scores using the software component, wherein the overall investment score indicates a relative investment value of the stock.

17. The method of claim 15, further comprising generating an investment recommendation based on at least the overall investment score using the software component.

18. The method of claim 15, wherein the plurality of the intermediate scores and the overall investment score are displayed in different colors depending on the corresponding values of each of the plurality of intermediate scores.

19. The method of claim 15, wherein the plurality of the intermediate scores includes Fundamentals Score, Technical Score, Analyst Score, and Management Score.

20. The method of claim 15, wherein the overall investment score is calculated based on the following equation:
$$Overall Investment Score = ( Birinyi Score * K 10 ) + ( Management Score * K 11 ) + ( Analyst Score * K 12 ) + ( Fundamental Score ) * K 13 ) ;$$
wherein K10, K11, K12, and K13 are numerical constants.
